(19) United States
(12) Patent Application Publication
(10) Pub. No.: US 2011/0053541 A1
(43) Pub. Date: Mar. 3, 2011

(54) DYNAMIC RANGE ON-DEMAND FOR RECEIVER APPLICATIONS

(75) Inventors: Douglas S. Jansen, Pelham, NH (US); Gregory M. Flewelling, Merrimack, NH (US)

(73) Assignee: BAE SYSTEMS Informantion and Electronic Systems Integration Inc., Nashua, NH (US)

(21) Appl. No.: 12/548,249

(22) Filed: Aug. 26, 2009

(51) Int. Cl. H04B 1/06

(52) U.S. Cl. 455/234.1

(57) ABSTRACT

Receiver power techniques are disclosed that allow for real-time adjustment of receiver dynamic range by virtue of supplied DC power, based on signal strengths currently received by the receiver. The disclosed techniques use real-time monitoring of receiver output to detect the presence of large signals, and to then adjust bias points in the receiver to reduce DC power consumption in the absence of large signals. By adapting the power to the current signal environment by autonomously adjusting the bias points, the mean power consumption of the receiver can be greatly reduced. This in turn has a number of benefits, such as increased battery life, decreased heat, increased circuit lifetime, and decreased noise figure.

### FIELD OF THE INVENTION

The invention relates to communication systems, and more particularly, to techniques for adjusting the dynamic range of a receiver in such a way as to reduce DC power when full dynamic range is not needed.

### BACKGROUND OF THE INVENTION

As is known, a communications receiver includes circuitry that receives input signals from an antenna, isolates a target signal from the various signals captured by the antenna by filtering out unwanted signals, amplifies the target signal to a level suitable for further processing, and converts (e.g., frequency conversion from transmit to IF band, demodulation, and decoding) the target signal into a form usable by the given application. The dynamic range of the receiver refers to the largest signal the receiver can process while remaining in the linear mode of operation (i.e., without saturating the receiver electronics). This dynamic range is generally a function of the DC power supplying current to the receiver.

In particular, as receiver saturation is typically undesirable, the DC power supplied to a receiver is set based on the maximum receiver performance needed for a given application. Thus, if signals of up to a certain magnitude are known to be received in a given application, then the DC power is set to accommodate that maximum signal magnitude. Once the DC power needed for a given application is determined, it is provided in a static fashion and is not adjusted, regardless of the strength of communication signals being received.

A disadvantage with such conventional receiver power schemes is the unnecessary power consumption when strong signals are not present. This unneeded power consumption shortens battery life (assuming battery-based receiver applications), increases the heat dissipation of the receiver circuitry, and decreases receiver lifetime (e.g., due to constant supply of max current). In addition, such static power schemes budgeted for worst case signal demands can also increase receiver noise figure. There is a need, therefore, for improved receiver power schemes.

### SUMMARY OF THE INVENTION

One embodiment of the present invention provides a method for autonomously controlling dynamic range of a receiver in real-time. The method includes sampling a target spectrum to provide a sampled signal, and analyzing the sampled signal to determine an optimal dynamic range of the receiver for processing the sampled signal, wherein the optimal dynamic range is with respect to a target excess power margin. The method continues with adjusting biasing to one or more receiver blocks, based on the optimal dynamic range. In one specific case, analyzing the sampled signal to determine an optimal dynamic range includes determining a maximum signal magnitude represented in the sampled signal. In one such case, analyzing the sampled signal may further include correlating the maximum signal magnitude to a corresponding bias control signal that will cause power associated with the optimal dynamic range to be provided. The target excess power margin can be, for example, 10% or less, such that 90% or more of the available power margin is used by the receiver in processing the sampled signal. Sampling the target spectrum can be carried out, for instance, by an analog-to-digital converter (assuming digital domain signal processing) or a peak detector (assuming analog domain signal processing). In some cases, bias control signals associated with the optimal dynamic range are applied to multiple locations of the receiver (so as to control the power margin available to those blocks). The sampling, determining, and adjusting can be repeated periodically, if so desired.

Another embodiment of the present invention provides a system for autonomously controlling dynamic range of a receiver in real-time. The system includes a circuit for sampling a target spectrum to provide a sampled signal, and a signal processor for analyzing the sampled signal to determine an optimal dynamic range of the receiver for processing the sampled signal, wherein the optimal dynamic range is with respect to a target excess power margin. The signal further includes bias adjust circuitry operatively coupled to the signal processor for adjusting biasing to one or more receiver blocks, based on the optimal dynamic range. In one particular example case, the signal processor includes a maximum signal magnitude module for determining a maximum signal magnitude represented in the sampled signal. In one such case, the signal processor further includes a bias control select module for correlating the maximum signal magnitude to a corresponding bias control signal that will cause the bias adjust circuitry to provide power associated with the optimal dynamic range. The target excess power margin can be, for example, 10% or less. The circuit for sampling the target spectrum can be, for instance, an analog-to-digital converter (assuming digital domain signal processing) or a peak detector (assuming analog domain signal processing). In some cases, bias control signals associated with the optimal dynamic range are applied to multiple locations of the receiver (so as to control the power margin available to those blocks). The system may be included, for instance, in a system-on-chip configuration (e.g., integrated circuit or chip set). A number of variations will be apparent in light of this disclosure.

For instance, in another embodiment, the system includes a signal processor for analyzing a sampled signal to determine an optimal dynamic range of the receiver for processing the sampled signal, wherein the optimal dynamic range is with respect to a target excess power margin. In this particular case, the signal processor includes a maximum signal magnitude module for determining a maximum signal magnitude represented in the sampled signal, and a bias control select module for correlating the maximum signal magnitude to a corresponding bias control signal that will cause the bias adjust circuitry to provide power associated with the optimal dynamic range. The system further includes bias adjust circuitry operatively coupled to the signal processor for adjusting biasing to one or more receiver blocks, based on the optimal dynamic range. The system may also include a circuit for sampling the target spectrum to provide the sampled signal. Bias control signals associated with the optimal dynamic range can be applied to multiple locations of the receiver, as needed if so desired. The system may be included in a system-on-chip configuration.

The features and advantages described herein are not all-inclusive and, in particular, many additional features and advantages will be apparent to one of ordinary skill in the art in view of the drawings, specification, and claims. Moreover, it should be noted that the language used in the specification has been principally selected for readability and instructional purposes, and not to limit the scope of the inventive subject matter.

### BRIEF DESCRIPTION OF THE DRAWINGS

FIG. 1a is a block diagram of a communications receiver system configured with dynamic range on-demand, in accordance with an embodiment of the present invention.

FIG. 1b is a block diagram of a signal processor that can be used in the system shown in FIG. 1a, configured in accordance with an embodiment of the present invention.

FIG. 2a is a schematic diagram of a differential pair circuit configured with an adjustable bias, in accordance with an embodiment of the present invention.

FIG. 2b is a schematic diagram of circuitry for providing the adjustable bias to the differential pair circuit of FIG. 2a, in accordance with an embodiment of the present invention.

FIG. 3a is a schematic diagram of an emitter follower circuit configured with an adjustable bias, in accordance with an embodiment of the present invention.

FIG. 3b is a schematic diagram of circuitry for providing the adjustable bias to the emitter follower circuit of FIG. 3a, in accordance with an embodiment of the present invention.

FIGS. 4a, 4b, and 4c each illustrate a schematic diagram of a tuned current source for providing an adjustable bias, in accordance with an embodiment of the present invention.

FIG. 5 illustrates a method for autonomously controlling dynamic range of a receiver in real-time, in accordance with an embodiment of the present invention.

### DETAILED DESCRIPTION OF THE INVENTION

Receiver power techniques are disclosed that allow for real-time adjustment of receiver dynamic range by virtue of supplied DC power, based on signal strengths currently received by the receiver. The disclosed techniques use real-time monitoring of receiver output to detect the presence of large signals, and to then adjust bias points in the receiver to reduce DC power consumption in the absence of large signals. By adapting the power to the current signal environment by autonomously adjusting the bias points, the mean power consumption of the receiver can be greatly reduced. This in turn has a number of benefits, such as increased battery life, decreased heat, increased circuit lifetime, and decreased noise figure.

System Architecture

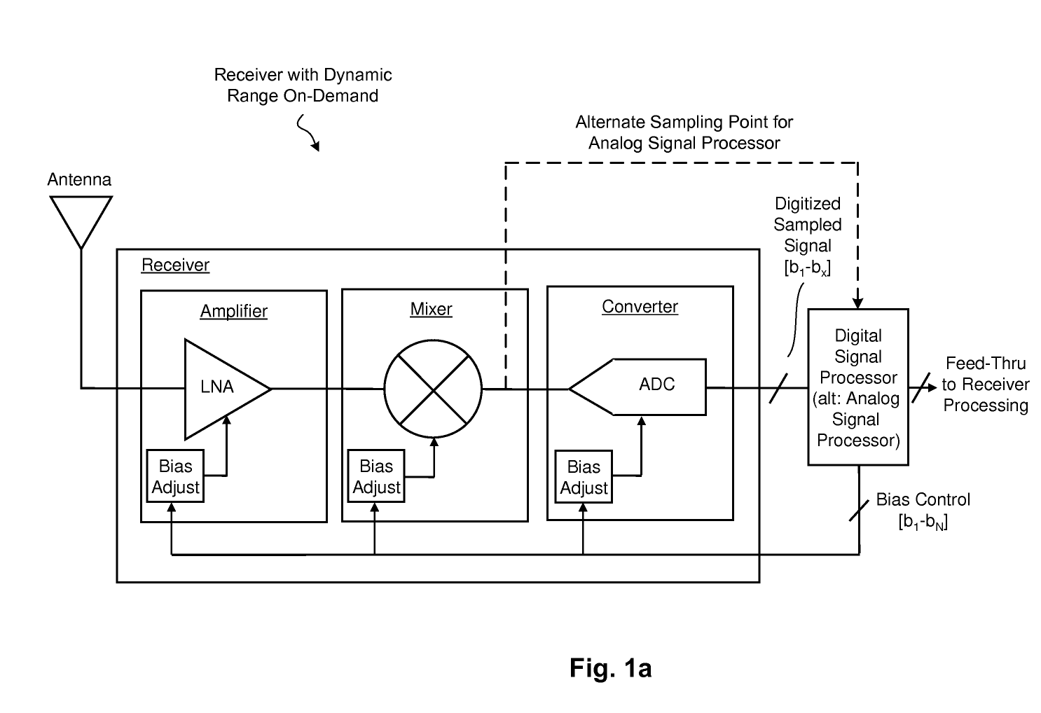

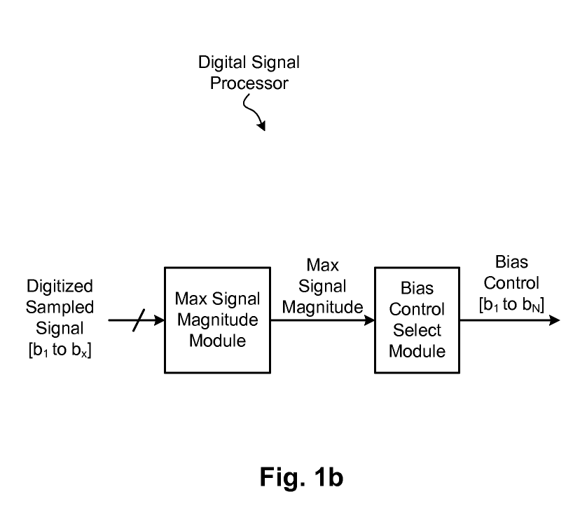

FIG. 1a is a block diagram of a communications receiver system configured with dynamic range on-demand, in accordance with an embodiment of the present invention. This system can be, for example, a receiver-on-chip configuration, but other embodiments can be implemented with discrete components.

As can be seen, the system includes an antenna operatively coupled to receiver front-end circuitry including a low noise amplifier (LNA), a mixer, and an analog-to-digital converter (ADC). Other standard receiver circuitry (e.g., IF filtering, demodulator, detected signal amplifier, speaker and/or monitor, etc) is not shown, but will be apparent in light of this disclosure. In addition to such standard componentry, the system further includes a digital signal processor (DSP) programmed or otherwise configured for controlling bias adjust circuits operatively coupled to each of the amplifier, mixer, and conversion stages of the receiver.

As will further be appreciated in light of this disclosure, the receiver can be in any configuration including both single and dual stage conversion. Likewise, the standard componentry of the receiver (e.g., antenna, LNA, mixer, converter, etc) can be implemented with any suitable technology, and may be configured as desired, depending on the demands of the target application. The present invention is not intended to be limited to any particular receiver architecture or signal processing scheme. Rather, the techniques described herein can generally be used in conjunction with any number of receiver designs and technologies, whether the application calls for broad or narrow band, high or low resolution, high or low power, analog or digital signal processing, short or long range, high or low sensitivity, discrete or integrated componentry, etc.

In operation, the antenna captures signals in the frequency band of interest (e.g., based on the antenna construction and frequency range of operation), and provides those signals to the LNA stage for amplification as typically done. The amplified signals may be filtered as necessary and are provided to the mixer stage, which down-converts from the transmission frequency band to the intermediate frequency (IF) band. The IF signal is then converted to its digital equivalent by the ADC. The resolution of the ADC can vary, and is typically in the range of 4 to 16 bits (b₁-bₓ, where x=4 to 16), depending on desired degree of conversion accuracy.

The digitized sample signal output by the ADC can then be provided both to the DSP as well as the receiver back-end processing circuitry (e.g., filtering, amplification, demodulation, and any other typical receiver functions). In the embodiment shown, the DSP is configured with feed-thru capability that allows the digitized sample signal to be passed to the receiver back-end. In such a case, the feed-thru path can be buffered or otherwise isolated from other DSP circuitry/functions. In other embodiments, the receiver back-end can be operatively coupled directly to the output of the ADC, with any necessary buffering to isolate the back-end from the DSP. Any number of suitable DSP connection schemes can be used here.

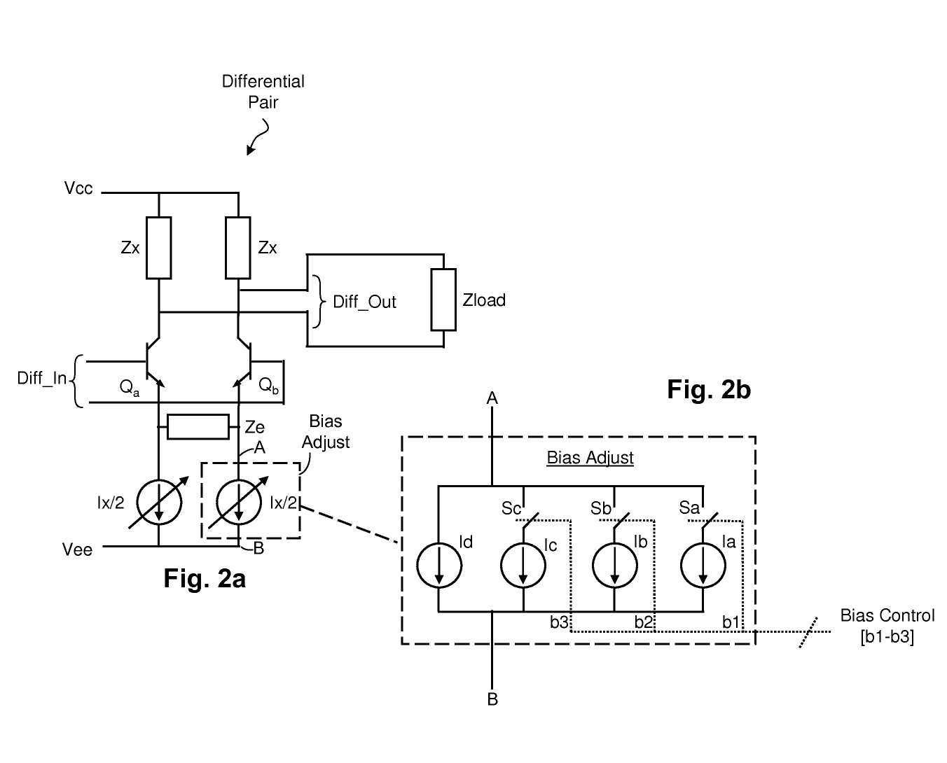

In any case, the DSP continuously monitors the digitized sampled signal provided by the ADC stage, and based on the maximum signal strength represented in that sample, outputs corresponding bias control signals to each of the bias adjust circuits. The bias control signals in turn cause the corresponding bias adjust circuits to provide the necessary amount of DC power to that particular receiver block, as will be explained with reference to FIGS. 2a-b, 3a-b, and 4a-c. Thus, the DSP performs real-time monitoring of digital receiver output to detect the presence of large signals. In presence of large signals, the DSP outputs bias control signals that effectively increase the DC power to one or more receiver stages, to increase linearity of the receiver. When large signals are not present, however, the DSP outputs bias control signals that effectively reduce DC power to one or more receiver stages.

The DSP can be implemented, for example, with a conventional digital signal processor programmed or otherwise configured to carry out the methodologies described herein. However, any suitable digital or analog signal processor can be used, such as a microprocessor or microcontroller configured with a number of input/output ports and a number of embedded routines for assessing signal strength and correlating that strength to a corresponding bias control signal. For instance, the digital output of the ADC can be applied to the digital inputs of the microcontroller, which then determines the greatest signal magnitude reflected in the digital sample, correlates that signal magnitude to a corresponding bias control word (e.g., using a look-up table indexed by signal magnitude) that will cause the bias adjust circuits to provide the desired amount of power (e.g., to prevent any saturation, but to conserve power by not supplying more than 110% of what is needed), and outputs that corresponding bias control word.

Further, note that the sampled signal may be analyzed in the analog domain by an analog signal processor, if so desired, and the present invention is not intended to be limited to digital signal processors. This alternate embodiment is shown in FIG. 1a, where one example of an alternate sampling point is the output of the mixer stage, and is provided to an analog signal processor (instead of a DSP). In one such example case, the analog signal processor may include peak detector circuit that outputs a DC voltage that corresponds to the maximum signal magnitude received, which can then be used to identify the desired bias control. For instance, a look-up table (e.g., indexed by the DC voltage produced by the peak detector) can be used to correlate that maximum analog signal (or by its corresponding DC voltage output by peak detector) to a corresponding bias control signal that will command the bias adjust circuits to set the DC power accordingly. Any number of processor and sampling schemes can be used.

The DC bias can be adjusted, for example, by changing gate/drain voltages, tail currents, or drain/collector resistors. Alternatively, DC bias can also be adjusted by swapping out higher power sub-circuits for lower power sub-circuits. Various example techniques and circuitries for adjusting the DC bias will be discussed with reference to FIGS. 2a-b, 3a-b, and 4a-c.

Signal Processor

FIG. 1b illustrates a block diagram of an example signal processor configured in accordance with one embodiment of the present invention. As can be seen, the processor of this example is configured for receiving a digital input signal and for generating a bias control signal, and includes a maximum signal magnitude module and a bias control select module. As will be appreciated in light of this disclosure, the signal processor may also be configured to receive an analog input signal and to generate a corresponding bias control signal.

These maximum signal magnitude and a bias control select modules can be implemented, for example, in hardware (e.g., gate-level logic, such as FPGA or ASIC), software (e.g., executable instructions stored on processor readable medium, that when executed by a processor, cause the processor to carry out functionalities described herein including maximum signal magnitude computation based on input signal and bias control select based on that max signal magnitude), firmware (e.g., routines embedded in microcontroller for carrying out functionalities described herein), or a combination thereof. The maximum signal magnitude module is programmed or otherwise configured for determining the maximum signal magnitude represented in the sampled signal (e.g., a fast Fourier transform with a peak search, peak detector circuit such as the kind employed by spectrum analyzers, etc), and the bias control select module is programmed or otherwise configured for correlating the maximum signal magnitude to a corresponding bias control signal that will provide power associated with the optimal dynamic range (e.g., look-up table indexed by max signal magnitude that outputs corresponding bias control signals, in response to the max signal magnitude being applied to table input).

Differential Pair with Adjustable Bias

FIG. 2a is a schematic diagram of a differential pair circuit configured with an adjustable bias, and FIG. 2b is a schematic diagram of circuitry for providing the adjustable bias to the differential pair circuit of FIG. 2a, in accordance with an embodiment of the present invention.

A differential pair is a basic building block and common circuit element for implementing any number of functions, such as those associated with LNA (e.g., differential pair configured as a differential amplifier), mixer (e.g., differential pair configured as the input transconductance stage of a Gilbert cell mixer), and the ADC (e.g., differential pair configured for comparison of input voltage to reference level). In accordance with this example embodiment shown in FIGS. 2a-b, a differential pair circuit can be configured with a bias adjust circuit thereby allowing bias of the particular function to be adjusted in real-time.

In more detail, the differential pair circuit includes a transistor pair (Qa and Qb), which converts an applied input voltage at the bases to an output current at the collectors. The differential input voltage is designated as Diff_In, and the differential output current is designated as Diff_Out. The differential output current can be applied to a load (Zload), which could be the output stage of an LNA or a Gilbert switching quad mixing the output signal with a local oscillator signal. Linearity is dependent on the semiconductor process used and how much emitter degeneration is used, which is impedance element Ze. When impedance Ze is a resistive element for broadband applications, high linearity can be achieved at the expense of lower gain and high noise figure. Narrow band applications can partially mitigate this shortcoming by utilizing reactive components (i.e., inductors or capacitors) for Ze. The matched impedances Zx connected at the collectors of the differential pair are generally used for shaping the frequency response and gain of the circuit.

With such a degenerated differential pair configuration, the gain is approximately set by the impedance values. As the current Ix is increased, the voltage range on the output is increased, which directly translates to increased dynamic range. As Ix is increased, the power delivered to the load (Zload) is also increased. In more detail, the circuit gain=(Zx∥Zload/2)/Ze. In addition, the DC power=(Vcc−Vee)*Ix, and the maximum output voltage (MaxOV)=(Zx∥Zload/2)*Ix. The maximum power delivered to the load (PDL) can therefore be computed as ½*(MaxOV²)*Zload/2.

As can be further seen with reference to FIG. 2b, the bias adjust circuit of this example embodiment, which is operatively coupled between nodes A and B of the differential pair circuit, includes four current sources (Ia, Ib, Ic, and Id), three of which can be switched in or out of circuit by corresponding switches (Sa, Sb, and Sc) that operate in response to the bias control (b1-b3) provided by the DSP. In particular: bit b1 controls switch Sa, which switches current source 1a in or out of circuit; bit b2 controls switch Sb, which switches current source 1b in or out of circuit; and bit b3 controls switch Sc, which switches current source 1c in or out of circuit. Current source 1d is always in circuit in this example configuration. Given that the bias control includes three bits in this example, there are a total of eight distinct DC power settings, which in turn provide eight distinct dynamic range settings.

As is known, parallel current sources add. A default position of the bias adjust circuit can be, for instance, when only current source 1d is sourcing current to the differential pair Qa and Qb. In this case, the bias control would be: 0,0,0, which would provide the lowest DC power level and corresponding dynamic range. Table 1 provides the bias control for the other seven possible DC power settings.

TABLE 1

| Bias Control | Switches | Current Sources | |
|---|---|---|---|
| (b3, b2, b1) | On | Active | DC Power |
| 0, 0, 0 | none (default) | Id only | Min |
| 0, 0, 1 | Sa | Ia + Id | .25 (Max) |
| 0, 1, 0 | Sb | Ib + Id | .375 (Max) |
| 0, 1, 1 | Sb, Sa | Ib + Ia + Id | .5 (Max) |
| 1, 0, 0 | Sc | Ic + Id | .625 (Max) |
| 1, 0, 1 | Sc, Sa | Ic + Ia + Id | .75 (Max) |
| 1, 1, 0 | Sc, Sb | Ic + Ib + Id | .875 (Max) |
| 1, 1, 1 | Sc, Sb, Sa | Ic + Ib + Ia + Id | Max |

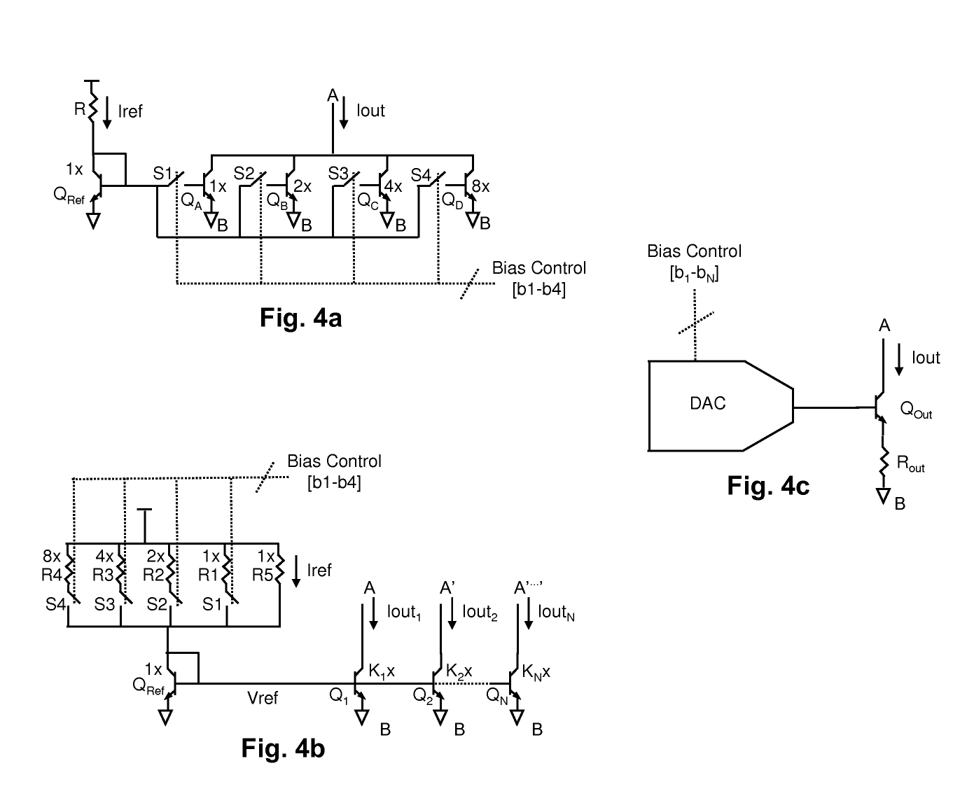

The transistors Qa and Qb shown in this example of FIG. 2a are bipolar NPN transistors, but other transistor types (e.g., BJT PNP, FETs) can be used, as will be apparent in light of this disclosure. The switches Sa, Sb, and Sc can also be bipolar NPN transistors (or FETs, etc). For instance, in one alternative embodiment, the transistors Qa and Qb as well as switches Sa, Sb, and Sc can be FETs and the current sources Ia, Ib, and Ic can be resistors. In another embodiment, the transistors Qa and Qb as well as switches Sa, Sb, and Sc can be FETs, and the current sources Ia, Ib, and Ic can be transistor based current sources. Specific example current sources that can be used will be discussed with reference to FIGS. 4a-c.

Any suitable impedance values can be used, depending on the particulars (e.g., desired gain, frequency response, etc) of the given application. In one specific example embodiment, the impedance values are as follows: Zx=150 ohms, Zload=200 ohms; and Ze=30 ohms. Assuming Vcc=5 VDC and Vee=0 VDC (or ground), such a configuration would provide a gain of about 2. Tables 2a and 2b each indicate the current Ix that will be provided with such an example configuration, along with the corresponding power, MaxOV, and maximum PDL.

TABLE 2a

| Current | Ix | Power | MaxOV | Max PDL |
|---|---|---|---|---|
| Source | (mAmps) | (mWatts) | (mVDC) | (μWatts) |
| Id | 2 | 10 | 120 | 36 |
| Id + Ia | 3 | 15 | 180 | 81 |
| Id + Ib | 4 | 20 | 240 | 144 |
| Id + Ic | 5 | 25 | 300 | 225 |

TABLE 2b

| Current | Ix | Power | MaxOV | Max PDL |
|---|---|---|---|---|
| Source | (mAmps) | (mWatts) | (mVDC) | (μWatts) |
| Id | 2 | 10 | 120 | 36 |
| Id + Ia | 3 | 15 | 180 | 81 |
| Id + Ia + Ib | 4 | 20 | 240 | 144 |
| Id + Ia + Ib + Ic | 5 | 25 | 300 | 225 |

The example of Table 2a assumes the following: current source Id is 2 mAmps, current source Ia is 1 mAmp, current source Ib is 2 mAmps, and current source Ic is 3 mAmps (to effectively provide a binary weighted switching scheme). Thus, a max Ix current of 8 mAmps can be provided (when all 4 current sources are switched in circuit or otherwise in circuit). The example of Table 2b assumes the following: current source Id is 2 mAmps, and each of current sources Ia, Ib, and Ic is 1 mAmp (to provide a thermometer coded switching scheme). Thus, a maximum Ix current of 5 mAmps can be provided (when all 4 current sources are in circuit). As will be appreciated in light of this disclosure, any combination of individual current sources Ia, Ib, Ic, and/or Id can be selected to provide a total current source (Ix) that represents the sum of all current sources that are in-circuit. The current sources may each have the same value, all different values, or a mix same and different values.

Emitter Follower with Adjustable Bias

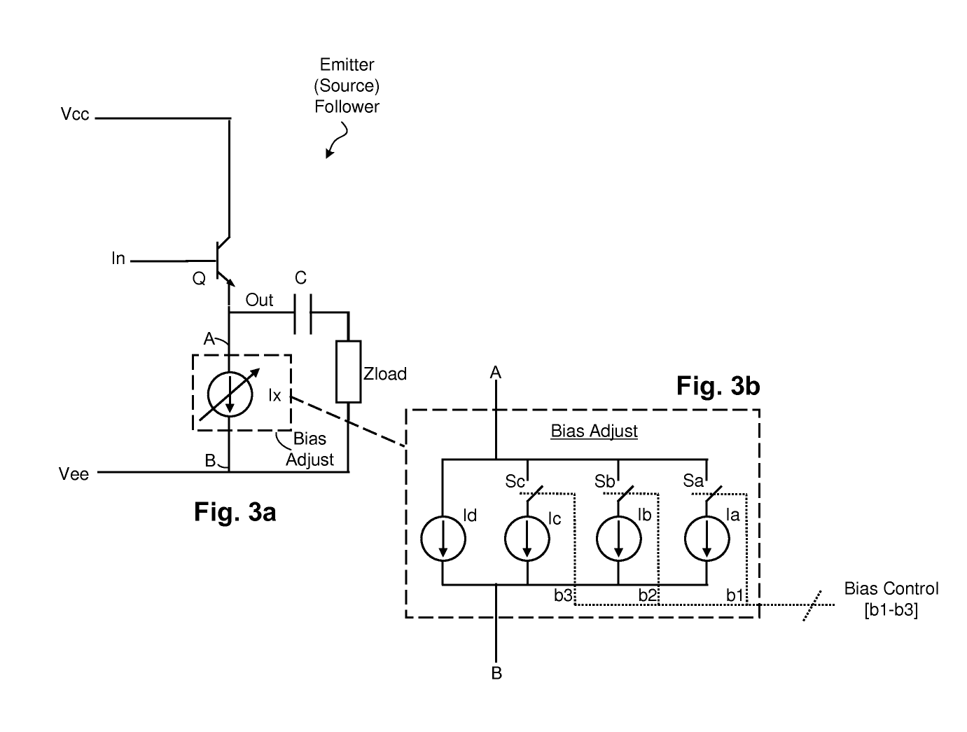

FIG. 3a is a schematic diagram of an emitter follower circuit configured with an adjustable bias, and FIG. 3b is a schematic diagram of circuitry for providing the adjustable bias to the emitter follower circuit of FIG. 3a, in accordance with an embodiment of the present invention.

An emitter follower is another basic building block and common circuit element for implementing any number of functions, such as those associated with LNA, mixer, and the ADC (e.g., emitter follower as output stage buffer). In accordance with this example embodiment shown in FIGS. 3a-b, an emitter follower circuit can be configured with a bias adjust circuit thereby allowing bias of the particular function to be adjusted in real-time, just as explained with reference to FIGS. 2a-b.

In more detail, the emitter follower circuit generally has a unity voltage gain. This means that any change in the base voltage (In) of transistor Q is generally provided at the emitter (Out). The capacitor C can be provided to filter out undesired lower frequency signals. The output signal can be applied to a load (Zload), which could be, for example, the next stage in the receiver (assuming the emitter follower is configured as an output stage buffer).

In this particular case, the maximum power delivered to the load (PDL) is a linear function of the current from current source Ix. It is generally determined by where the transistor Q saturates. In more detail, assuming unity gain (gain=1), the DC power=Ix*Vcc, the maximum power delivered to load can be computed as follows: Max PDL=½(Vcc−Vce(sat))*Ix.

As can be further seen with reference to FIG. 3b, the bias adjust circuit of this example embodiment, operatively coupled between nodes A and B of the emitter follower circuit, is configured in a similar fashion as to the bias adjust circuit described with reference to FIG. 2b, and that previous description and various bias adjust circuit details are equally applicable here.

The transistor Q shown in this example of FIG. 3a is a bipolar NPN transistor, but other transistor types (e.g., BJT PNP, FETs) can be used, as will be apparent in light of this disclosure. As previously explained, the switches Sa, Sb, and Sc can also be bipolar NPN transistors (or FETs, etc). For instance, in one alternative embodiment, the transistor Q as well as switches Sa, Sb, and Sc can be FETs and the current sources Ia, Ib, and Ic can be resistors. In another embodiment, the transistor Q as well as switches Sa, Sb, and Sc can be FETs, and the current sources Ia, Ib, and Ic can be transistor based current sources. Various specific example current sources that can be used will be discussed with reference to FIGS. 4a-c.

For purposes of one specific example embodiment, assume the following emitter follower circuit parameters: unity gain, Zload=200 ohms, Vcc=5 VDC, Vee=0 VDC (or ground), and Vce(sat)=0.5 VDC. Tables 3a and 3b each indicate the current Ix that will be provided with such an example configuration, along with the corresponding power, MaxOV, and maximum PDL.

TABLE 3a

| Current | Ix | Power | Max PDL |
|---|---|---|---|
| Source | (mAmps) | (mWatts) | (mWatts) |
| Id | 2 | 10 | 4.5 |
| Id + Ia | 3 | 15 | 6.75 |
| Id + Ib | 4 | 20 | 9 |
| Id + Ic | 5 | 25 | 11.25 |

TABLE 3b

| Current | Ix | Power | Max PDL |
|---|---|---|---|
| Source | (mAmps) | (mWatts) | (mWatts) |
| Id | 2 | 10 | 2 |
| Id + Ia | 3 | 15 | 3 |
| Id + Ia + Ib | 4 | 20 | 4 |
| Id + Ia + Ib + Ic | 5 | 25 | 5 |

The previous assumptions and discussion with respect to example current source values and configurations (e.g., binary weighted, thermometer coded, etc) explained with reference to Tables 2a-b are equally applicable here. Recall that the current sources can be selected in any combination and may each have the same value, all different values, or a mix same and different values.

Tuned Current Source

FIGS. 4a, 4b, and 4c each illustrate a schematic diagram of a tuned current source for providing an adjustable bias, in accordance with an embodiment of the present invention. Any of these example configurations can be used to implement bias adjust circuits shown in FIGS. 1, 2a-b and 3a-b. Other embodiments may be implemented differently, such as with switched resistors or other suitable impedance devices, in a binary weighted scheme or a thermometer coded scheme.

In the specific example of FIG. 4a, the reference current I_{ref} is kept constant, and is set by resistor R and the reference transistor Q_{ref}. The output current Iₒᵤₜ is determined by the transistors QA, QB, QC, and QD, and which of the switches S1, S2, S3, and S4 are on (closed). The switches S1, S2, S3, and S4 are 4-bit binary weighted (responsive to the bias control bits b1, b2, b3, and b4, respectively), so the output range of the current source coupled between nodes A and B is 0 to (2⁴−1)*I_{ref}. In this example embodiment, Vcc can be used to provide I_{ref}, and Vee at node B is set to 0 VDC (ground). Further note that this embodiment can be implemented as an integrated circuit (e.g., system-on-chip or chip set) using standard CMOS processing, and the corresponding transistor sizes are indicated, where transistors Q_{ref} and Q_{A} are sized to 1×, transistor Q_{B} is sized to 2×, transistor Q_{C} is sized to 4×, and transistor Q_{D} is sized to 8×. As is known, the transistor size generally corresponds to the transistor transconductance, which in turn corresponds to the current that can be sourced by that transistor. In this case, the transistor sizes are configured for binary weighting. The switches S1, S2, S3, and S4 can also be implemented using any suitable switch technology (e.g., CMOS FETs, BJTs, single-pole single throw switches, etc), depending on factors such as frequency and power of signals being switched, as well as other parameters such as desired switching speed and on-resistance. Alternative embodiments can be implemented, for instance, with discrete components (any number of transistor, switch, resistor, and/or other component types can be used) on a printed circuit board or other suitable substrate.

In the specific example of FIG. 4b, the reference current I_{ref} is switched (adjustable). In more detail, the reference current I_{ref} can be set depending on which of resistors R1-R4 are switched in by corresponding switches S1-S4 (if any), resistor R5, and the reference transistor Q_{ref}. The switches S1, S2, S3, and S4 are 4-bit binary weighted (responsive to the bias control bits b1, b2, b3, and b4, respectively). Just as with the output transistor sizes of the example configuration shown in FIG. 4a, the resistor sizes are configured for binary weighting, where resistors R1 and R5 are sized to 1×, resistor R2 is sized to 2×, resistor R3 is sized to 4×, and resistor R4 is sized to 8×. The previous discussion relevant to FIG. 4a with reference to implementation (e.g., system-on-chip or chip set, CMOS, discrete components on PCB, switch technology, etc) is equally applicable here. The reference voltage V_{ref} can then be passed to multiple places throughout a given application circuit, as needed. Each of the output currents Iₒᵤₜ₁ (node A), Iₒᵤₜ₂ (node A′), . . . I_{outN} (node A′ . . . ′) is determined by how much current is going through the reference transistor Q_{ref} and the corresponding scaling constant K of transistors Q₁ through Q_{N} (i.e., K₁, K₂, . . . K_{N}, respectively). In this example embodiment, the output current range is from I_{ref}*K_{N} to 2⁴*I_{ref}*K_{N}. Further, note that Vcc can be used to provide I_{ref}, and Vee at node B is set to 0 VDC (ground).

In the specific example of FIG. 4c, the output current Iₒᵤₜ is set using a digital-to-analog converter (DAC), along with an output transistor Qₒᵤₜ and Rₒᵤₜ operatively coupled between nodes A and B. The output current Iₒᵤₜ can be computed as: (V_{DAC}−Vbe)/Rₒᵤₜ, where V_{DAC} is the output voltage of the DAC (which can be determined by the bias control bits b1, b2, . . . b_{N}, where N depends on the resolution of the DAC) and Vbe is governed by the semiconductor process employed in fabricating the output transistor Qₒᵤₜ. A typical range for Vbe is about 0.4 to 0.9 volts, for standard silicon or silicon germanium semiconductor processes. Note that other suitable semiconductor processes can be used in fabricating the transistors, such as indium phosphide (InP) bipolar processes, as well as gallium arsenide (GaAs) processes, and the present invention is not intended to be limited to any particular one or set.

Any of these sub-circuits/components (e.g., transistors, resistors, switches) can be, for instance, bipolar, CMOS, HEMT, etc, or any combination thereof. The transistors shown in the examples are bipolar NPN transistors, but other transistor types (e.g., BJT PNP, FETs) can be used, as will be apparent in light of this disclosure. Moreover, the circuitry configured in accordance with an embodiment of the present invention can be implemented, for example, with discrete componentry (e.g. printed circuited board or card populated with discrete components) or as one or more integrated circuits (e.g., system-on-chip, or chip set formed using any number of suitable semiconductor processes). In one example case, Silicon Germanium (SiGe) processes are used, such as IBM processes 5 HP, 7 HP or 8 HP. Indium Phosphide, regular Silicon, Indium Gallium Phosphide, Gallium Arsenide are all viable processes generally available that can be used to implement an embodiment of the present invention.

Methodology

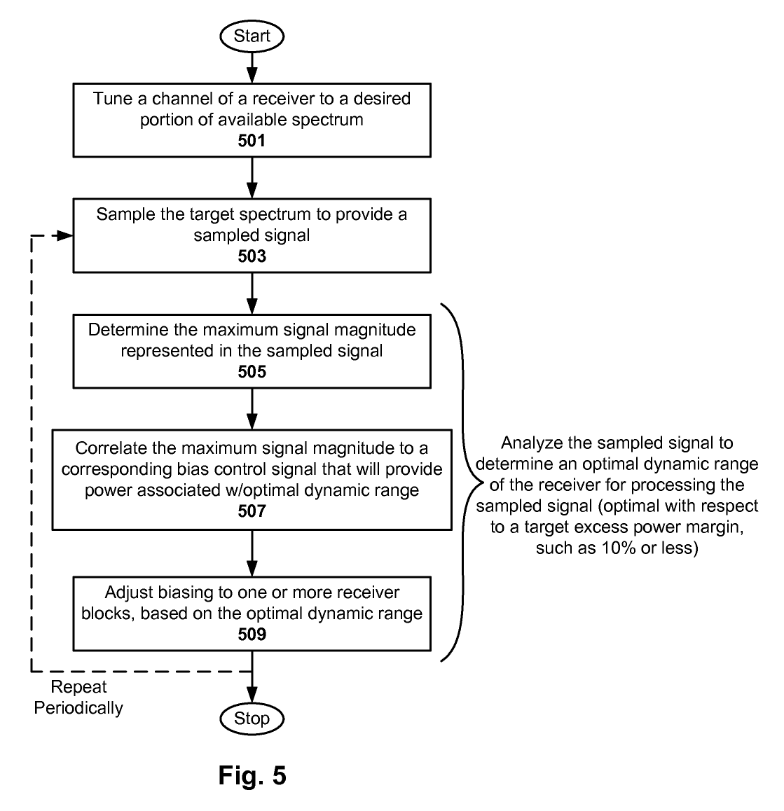

FIG. 5 illustrates a method for autonomously controlling dynamic range of a receiver in real-time, in accordance with an embodiment of the present invention. The method can be carried out, for example, by the system described with reference to FIGS. 1a-b, although any number of receiver architectures can be configured to carry out the method, using software, hardware, and/or firmware.

The method begins with tuning 501 a receiver channel to a desired portion of available spectrum. For reference purposes, this portion is generally referred to as the target spectrum. At this initial point or tuning phase, the receiver can be in a default state with respect to its dynamic range and any other configurable parameters (e.g., channel tuning, high sensitivity, low power, reduced dynamic range). The default state can be any combination of receiver parameters, set as so desired, depending on factors associated with the given application, such as available receiver power, typical signal strength experienced in target spectrum, and/or presence of interference. Note that some receivers may operate at the default channel (i.e., tuning is optional).

The method continues with sampling 503 the target spectrum, to provide a sampled signal. This sampling can be achieved, for instance, using the front-end of the receiver, wherein signals are captured by the receiver antenna, filtered as necessary, down-converted from the transmission band to the IF band, and then converted from analog to digital by an ADC converter of the receiver. A sample of this digitized signal can be taken over a period of time (e.g., 10 milliseconds to 10 seconds). However, any suitable sampling method can be used. In addition, further note that the sampling can occur at a number of locations within the receiver (e.g., in the transmit frequency domain, in the IF domain, in the analog domain, in the digital domain, etc). Depending on the sampling point, correlation or other sample processing may be necessary to translate the sampled signal so that its actual impact on dynamic range can be assessed. In a more general sense, any sampling scheme can be used, so long as the sampled signal can be assessed or otherwise used to identify a corresponding dynamic range within the given receiver architecture.

The method continues generally with analyzing the sampled signal to determine an optimal dynamic range of the receiver for processing the sampled signal. Optimal is used here with respect to a target excess power margin (such as 10% or less, where 90% or more of the supplied power range is used). In one example case, the receiver is always in linear mode or otherwise mostly remains in linear mode (e.g., no saturation that perseveres longer than 5 milliseconds), and always uses a high percentage (e.g., 66% or more) of the available power margin. The amount of allowable saturation (if any) and the percentage of available power margin used will depend on demands of the given application, and can vary from one embodiment to the next. More demanding applications may call for, for instance, 100% linear mode operation (meaning no saturation, however fleeting, is acceptable) and an excess power margin of less than 5% (meaning more than 95% of the available power margin is used by the receiver).

In the example embodiment shown, the analysis includes determining 505 the maximum signal magnitude represented in the sampled signal. The signal magnitude will generally correspond to a required amount of power, so that the signal can be processed through the receiver architecture without causing saturation of the receiver. Conventional signal magnitude measurement techniques can be used (e.g., a fast Fourier transform with a peak search or peak detector circuit). Again, this determining 505 of maximum signal magnitude can be made with conventional measurement techniques in the analog or digital domain, time or frequency domain, and based on data sampled from any suitable location within the receiver architecture.

The analysis continues with correlating 507 the maximum signal magnitude to a corresponding bias control signal that will provide power associated with the optimal dynamic range. The amount of power can be, for instance, the power required to process the sampled signal, so as to prevent undesired saturation and/or excess power consumption, as defined for a given application. This correlation (effectively, a bias control selection) can be accomplished, for example, using a look-up table that matches the maximum signal magnitude to a corresponding bias control signal or power level setting (e.g., that provides a desired degree of margin to avoid saturation). The table can be populated, for example, based on empirical and/or theoretical data. In some cases, the look-up table may provide a bias control code for multiple blocks of the receiver circuitry, each associated with an amount of power required to process the sampled signal in accordance with desired performance (e.g., desired excess power margin, etc).

Table 4 demonstrates an example look-up table, in accordance with an embodiment of the present invention. As can be seen, the table is indexed by the maximum signal amplitude, thereby allowing the signal processor to perform a quick look-up to obtain corresponding N-bit bias control signals for each of three receiver blocks. Other embodiments may include more or less receiver blocks to be bias adjusted. Also, the maximum dynamic range (MDR) and resolution of this particular look-up table are 2 V-peak and 0.005 V-peak (e.g., N=9 bits), respectively, but greater or lower MDR and resolution can be used, depending on factors such the desired accuracy and available processing power.

TABLE 4

| Max Signal | LNA Bias | Mixer Bias | ADC Bias |
|---|---|---|---|
| Magnitude | Control | Control | Control |
| (V-peak) | (b_{N} . . . b₁) | (b_{N} . . . b₁) | (b_{N} . . . b₁) |
| .010 | 00 . . . 10 | 00 . . . 01 | 00 . . . 10 |
| .015 | 00 . . . 11 | 00 . . . 11 | 00 . . . 11 |
| .020 | 01 . . . 00 | 01 . . . 00 | 01 . . . 01 |
| .025 | 01 . . . 01 | 01 . . . 01 | 01 . . . 11 |
| . . . | . . . | . . . | . . . |
| 1.85 | 11 . . . 00 | 11 . . . 00 | 11 . . . 00 |
| 1.90 | 11 . . . 01 | 11 . . . 01 | 11 . . . 01 |
| 1.95 | 11 . . . 10 | 11 . . . 00 | 11 . . . 10 |
| 2.00 | 11 . . . 11 | 11 . . . 11 | 11 . . . 11 |

Still in other embodiments, the maximum signal amplitude can be applied to an algorithm configured to compute in real-time a corresponding target power level for each receiver block. Such an algorithm can be trained or otherwise configured to select the corresponding target power level based on empirical and/or theoretical data. In such a case, once the target power level is known, the corresponding bias control signal can then be identified or otherwise determined.

The method continues with adjusting 509 biasing (power) to one or more receiver blocks, based on the optimal dynamic range. The margin of additional power provided in excess of the power need to prevent saturation (e.g., not counting impulse or transient signals) can be, for example, 1% to 10%. For example, if a maximum signal amplitude of 5 Vpeak is detected, then the biasing can be adjusted to allow processing signals having amplitudes up to 5.1 Vpeak (about a 2% excess power margin, or 100 mVpeak). Thus, if large interfering signals in the sampled signal would drive the receiver to saturation when weaker signals of interest are present, the method can effectively generate appropriate commands to increase dynamic range. In contrast, conventional solutions either don't address the saturation or in some cases assert attenuation, which makes it impossible to detect the weaker signals of interest (which are attenuated along with the large interfering signals), particularly when the difference between the small and large signals is significant. If no large interfering signals are present in the sampled signal, the method can maintain, for example, commands for default high sensitivity, low power, and reduced dynamic range state. As previously explained, the bias control can be applied to multiple locations of the receiver architecture, or to a single location is so desired. In one example embodiment, the bias control commands are applied to receiver channel dynamic range control knobs, such as those associated with adjustable bias reference generators, adjustable current sources, adjustable load resistors, and any combination of these in any active signal path circuit such as amplifiers, attenuators, variable gain amplifiers and mixers. With such bias adjustments, the new state of receiver channel is able to accommodate large signals without saturating and without wasteful higher power utilization.

The method can be continuously repeated in real time. For instance, in the example embodiment shown in FIG. 5, steps 503, 505, 507, and 509 can be repeated periodically as needed. In one such case, the method is repeated every second. Other embodiments may repeat more often (e.g., every 50 to 500 milliseconds), while other embodiments may repeat less frequently (e.g., every 2 to 30 seconds). The repetition frequency will depend on factors such as the impact of saturation on the receiver application, desired rate of power consumption for executing the method, and processing power available for carrying out functional steps such as 505, 507 and 509.

The foregoing description of the embodiments of the invention has been presented for the purposes of illustration and description. It is not intended to be exhaustive or to limit the invention to the precise form disclosed. Many modifications and variations are possible in light of this disclosure. It is intended that the scope of the invention be limited not by this detailed description, but rather by the claims appended hereto.

What is claimed is:

1. A method for autonomously controlling dynamic range of a receiver in real-time, comprising:
sampling a target spectrum to provide a sampled signal;
analyzing the sampled signal to determine an optimal dynamic range of the receiver for processing the sampled signal, wherein the optimal dynamic range is with respect to a target excess power margin; and
adjusting biasing to one or more receiver blocks, based on the optimal dynamic range.

2. The method of claim 1 wherein analyzing the sampled signal to determine an optimal dynamic range comprises:
determining a maximum signal magnitude represented in the sampled signal.

3. The method of claim 2 wherein analyzing the sampled signal to determine an optimal dynamic range further comprises:
correlating the maximum signal magnitude to a corresponding bias control signal that will cause power associated with the optimal dynamic range to be provided.

4. The method of claim 1 wherein the target excess power margin is 10% or less.

5. The method of claim 1 wherein sampling a target spectrum is carried out by an analog-to-digital converter.

6. The method of claim 1 wherein sampling a target spectrum is carried out by a peak detector.

7. The method of claim 1 wherein bias control signals associated with the optimal dynamic range are applied to multiple locations of the receiver.

8. The method of claim 1 wherein the sampling, determining, and adjusting are repeated periodically.

9. A system for autonomously controlling dynamic range of a receiver in real-time, comprising:
a circuit for sampling a target spectrum to provide a sampled signal;
a signal processor for analyzing the sampled signal to determine an optimal dynamic range of the receiver for processing the sampled signal, wherein the optimal dynamic range is with respect to a target excess power margin; and
bias adjust circuitry operatively coupled to the signal processor for adjusting biasing to one or more receiver blocks, based on the optimal dynamic range.

10. The system of claim 9 wherein the signal processor for analyzing the sampled signal to determine an optimal dynamic range comprises:
a maximum signal magnitude module for determining a maximum signal magnitude represented in the sampled signal.

11. The system of claim 10 wherein the signal processor for analyzing the sampled signal to determine an optimal dynamic range further comprises:
a bias control select module for correlating the maximum signal magnitude to a corresponding bias control signal that will cause the bias adjust circuitry to provide power associated with the optimal dynamic range.

12. The system of claim 9 wherein the target excess power margin is 10% or less.

13. The system of claim 9 wherein the circuit for sampling a target spectrum is an analog-to-digital converter.

14. The system of claim 9 wherein the circuit for sampling a target spectrum is a peak detector.

15. The system of claim 9 wherein bias control signals associated with the optimal dynamic range are applied to multiple locations of the receiver.

16. The system of claim 9 wherein the system is included in a system-on-chip configuration.

17. A system for autonomously controlling dynamic range of a receiver in real-time, comprising:
a signal processor for analyzing a sampled signal to determine an optimal dynamic range of the receiver for processing the sampled signal, wherein the optimal dynamic range is with respect to a target excess power margin, the signal processor comprising:
a maximum signal magnitude module for determining a maximum signal magnitude represented in the sampled signal; and
a bias control select module for correlating the maximum signal magnitude to a corresponding bias control signal that will cause the bias adjust circuitry to provide power associated with the optimal dynamic range; and
bias adjust circuitry operatively coupled to the signal processor for adjusting biasing to one or more receiver blocks, based on the optimal dynamic range.

18. The system of claim 17 further comprising a circuit for sampling the target spectrum to provide the sampled signal.

19. The system of claim 17 wherein bias control signals associated with the optimal dynamic range are applied to multiple locations of the receiver.

20. The system of claim 17 wherein the system is included in a system-on-chip configuration.
